(19) United States
(12) Patent Application Publication
(10) Pub. No.: US 2024/0326298 A1
(43) Pub. Date: Oct. 3, 2024

(54) STRUCTURAL TEMPLATE FOR PRODUCING A STAMPING TOOL FOR STAMPING A THIN-FILM ELEMENT, USE OF A STRUCTURAL TEMPLATE, AND METHOD FOR PROVIDING A STRUCTURAL TEMPLATE

(71) Applicant: Karlsruher Institut für Technologie, Karlsruhe (DE)

(72) Inventors: Benjamin FRITZ, Karlsruhe (DE); Ruben HÜNIG, Karlsruhe (DE); Moritz LUCK, Karlsruhe (DE); Guillaume GOMARD, Mannheim (DE)

(21) Appl. No.: 18/573,606

(22) PCT Filed: Jun. 28, 2022
(86) PCT No.: PCT/EP2022/067634

§ 371 Date: Dec. 22, 2023

(30) Foreign Application Priority Data
Jun. 30, 2021 (DE) 10 2021 206 851.0

(51) Int. Cl. B29C 33/42; B29C 33/38; B29C 59/02; B81C 1/00

(52) U.S. Cl. CPC B29C 33/42; B29C 33/3842; B29C 59/022; B81C 1/00206; B29C 2059/023

(57) ABSTRACT

According to one aspect, the present invention relates to a structural template (1) for producing a stamping tool for stamping a thin-film element, the structural template (1) comprising: a substrate (10) having a surface (10A), wherein at least a portion of the surface (10A) has a microscopic structure (12) comprising a plurality of microscopic structural elements (14), the structural elements of the plurality of structural elements (14) each having a nanoscopic structure (16), and the plurality of structural elements (14) being arranged on the surface (10A) of the substrate (10) with a predefined amount of disorder. Other aspects relate to a use of the structural template to produce a stamping tool for stamping a thin-film element, to a method for providing a structural template for producing a stamping tool for stamping a thin-film element, and to a computer program product.

The present invention relates to a structural template for producing a stamping tool for stamping a thin-film element, a use of a structural template for producing a stamping tool for stamping a thin-film element, and a method for providing a structural template for producing a stamping tool for stamping a thin-film element.

At present, there are no transparent, broadband and angle-tolerant anti-reflective coatings on the market, for example for solar modules. All coatings produced using conventional anti-reflective methods such as thin films, nanostructuring, microstructuring or a combination thereof exhibit shine and/or diffraction effects.

It is known that plant surfaces, such as the surface of rose petals, have particularly good properties. The surface of a rose petal has broadband and angle-independent anti-reflective properties. Furthermore, it does not exhibit any shine or diffraction effects.

With their invention, which has been filed with the German Patent and Trademark Office (file number 10 2020 209 106.4) and the content of which is hereby incorporated by reference and included in this description, the inventors have discovered how the surface structure of e.g. a rose petal can be transferred to a stamping tool repeatedly and on a large scale or over a large area in order to produce an anti-reflective foil in a roll-to-roll stamping process, for example.

It is the object of the present invention to provide a structural template for producing an improved stamping tool, whereby stamping of a thin-film element, such as an anti-reflective foil, can be improved.

This object is solved by the independent claims. Preferred embodiments result from the respective dependent claims.

One aspect of the present invention relates to a structural template for producing a stamping tool for stamping a thin-film element, the structural template comprising:
a substrate with a surface,
wherein at least a partial area of the surface has a microscopic structure that comprises a plurality of microscopic structural elements,
wherein the structural elements of the plurality of structural elements each have a nanoscopic structure, and
wherein the plurality of structural elements are arranged on the surface of the substrate with a specified degree of disorder.

Advantageously, the structural template according to the invention can be produced easily and inexpensively. With the use of this structural template, the optimal optical properties of certain plant structures, such as the rose petal, can be imitated and simplified and transferred to a stampable element, wherein advantageously the structural template does not have any unevenness and/or inhomogeneities. The inventors have recognized that roll-to-roll stamping of an anti-reflective foil, for example, can be improved based on the structure of e.g. the rose petal by imitating this structure but reducing or even avoiding unevenness and inhomogeneities such as leaf veins and/or defects, which petals can have, in the structural template.

By means of the structural template, cost-effective, precise and rapid stamping, in particular in a roll-to-roll process, of a thin-film element, such as a foil for coating a solar module, can be ensured and at the same time shine and diffraction effects of the stamped thin-film element can be avoided.

In particular, the anti-reflective effect can be further improved by providing a nanoscopic structure on the structural elements. In other words, by providing a nanoscopic structure on the structural elements, the anti-reflective properties of a thin-film element into which the microscopic structure has been stamped can be improved. In addition, the nanoscopic structure has the effect that foreign particles cannot adhere to the microscopic structure, which gives the microscopic structure self-cleaning properties. Due to the disorder in the arrangement of the structural elements, there is no short-range or long-range order in the microscopic structure, whereby diffraction effects and shine of the thin-film element into which the microscopic structure has been stamped can be reduced or eliminated.

In the following, the terms “microscopic structure” and “microstructure” can be used interchangeably. In addition, the terms “nanoscopic structure” and “nanostructure” can be used interchangeably.

In the context of this description, the term “microscopic” is understood to mean that the proportions or dimensions of the microscopic structure are in the order of magnitude or in the range of 1 to 300 micrometers.

The term “nanoscopic”, however, means that the proportions or dimensions of the nanoscopic structure are in the order of magnitude or in the range of 100 to 3000 nanometers.

The thin-film element is preferably a foil used in particular to coat solar modules. The thin-film element can also be a thin stampable plate or disk.

The stamping tool is preferably a cylindrical roller, on the jacket of which a sheet is arranged, which has either a plurality of negative or positive images of the surface structure of the structural template. The stamping tool can also be a die. The stamping tool can be produced using the invention (file number 10 2020 209 106.4) filed earlier.

The following describes the structural template in relation to an xyz coordinate system, where the z-axis describes the vertical direction in the Earth's reference system and the x or y-axis describes the horizontal direction in the Earth's reference system.

The substrate can include or be made of a polymer. The substrate is preferably a fully polymerized photoresist treated using wet-chemical dissolution.

The substrate can be substantially cuboid or cube-shaped. The surface of the substrate can have a top and an opposite bottom in the vertical direction.

The substrate can be a silicon wafer.

The microscopic structure can be arranged, for example, on the top or bottom of the surface. A part of the top or bottom of the surface can have the microscopic structure. The entire top or the entire bottom can also have the microscopic structure. In other words, the entire top or the entire bottom can be covered with the microscopic structure. The microscopic structure can also extend over the entire surface of the substrate. The entire surface of the substrate can be covered with the microscopic structure.

Preferably only the top of the surface of the substrate has the microscopic structure. More preferably, the entire top is covered with the microscopic structure.

According to the invention, the microscopic structure comprises a plurality of microscopic structural elements, the lateral surfaces of which each have a nanoscopic structure. This structure, comprising the microstructure of the structural elements and the nanostructure on the lateral surfaces, can be referred to as a “hierarchical structure” in the following.

The hierarchical structure of the microscopic structure and integrated nanostructure preferably imitates the surface structure of certain plant leaves, such as the rose petal.

In the context of this description, a microscopic structural element of the plurality of microscopic structural elements is to be understood as a three-dimensional, in particular geometric, object. The geometric object can in particular be freely shaped in three dimensions. The geometric object can have a surface area or base and a apex and project from the base toward the apex. The surface of the structural element on which the structural element can stand and from which it projects is referred to as the surface area or base. The surface opposite the surface area or base or the point opposite the surface area or base, which has the greatest vertical distance to the surface area or base of the structural element, is referred to as the apex. The surface of the structural element between the base and the apex is referred to as the lateral surface of the structural element. A line on the lateral surface that extends substantially in a vertical direction between the apex and the base of the structural element is referred to as generating or surface lines.

Accordingly, the structural element can be a cuboid, a cube or a semi-sphere, for example. The structural element can be conical or tapered between the base and the apex. The structural element can be a pyramid or a cone, in particular an elliptical cone.

Preferably, the plurality of microscopic structural elements is a plurality of microscopic cones. One structural element of the plurality of structural elements can be a microscopic cone. Several of the plurality of structural elements can be microscopic cones. All of the plurality of structural elements can be microscopic cones.

A cone is a geometric object defined by the radius of its surface area or base and the height of its apex. In an axial cross-section, a cone has a triangular shape. The area between the base and the apex that surrounds the cone is called the lateral surface. A line on the lateral surface that extends in the radial and axial directions of the cone between the apex and the base is referred to as a generating or surface line. A cone can have a circular or elliptical surface area or base.

The base diameter of a subset or all of the plurality of cones can be between 0.5 and 150 micrometers, preferably between 1 and 100 micrometers, more preferably between 3 and 50 micrometers, and most preferably between 5 and 20 micrometers.

One or more structural elements, in particular all, of the plurality of structural elements are preferably designed such that they protrude or project substantially in the vertical direction from the surface of the substrate. The structural elements can project from the top of the substrate or from the bottom of the substrate, for example.

Preferably, all structural elements of the plurality of structural elements have a nanoscopic structure. Additionally or alternatively, the nanoscopic structure of a structural element of the plurality of structural elements is preferably formed in the lateral surface of the structural element.

Preferably, the nanoscopic structure of at least two structural elements, a subset or all structural elements of the plurality of structural elements differs. Each structural element of the plurality of structural elements can have a different or an individual nanoscopic structure. Alternatively, all structural elements of the plurality of structural elements can have an identical nanoscopic structure.

Advantageously, the anti-reflective effect of the microstructure can be further increased by different nanostructures.

Preferably, the nanoscopic structure comprises elevations and/or depressions that extend in paths between the apex and the base of a structural element along a generating or surface line of the structural element. In particular, the nanoscopic structure can comprise wrinkle-like formations or folds that extend between the apex and the base of a structural element along a generating or surface line of the structural element.

These fold-like formations or folds can diverge from the apex to the base. This can guarantee spectrally non-selective behavior.

More preferably, the nanoscopic structure is periodic. The nanoscopic structure preferably has a period length between 200 and 3000 nanometers, more preferably a period length between 400 and 2000 nanometers, and even more preferably a period length between 600 and 1800 nanometers.

The nanoscopic structure can also comprise tube-like paths that extend from the apex to the base in the radial and axial or vertical directions of a structural element. The paths of the nanostructure are preferably arranged along a generating or surface line or offset from one another in the vertical and horizontal directions on the lateral surface of the structural elements. For example, four first paths can extend from the apex to the base, four second paths can then extend in the interstices on the lateral surface between the four first paths, with the four second paths being vertically and radially offset from the four first paths, eight third paths can then extend in the interstices on the lateral surface between the four first and four second paths, with the eight third paths being vertically and radially offset from the four first and four second paths, and so on. The elevations and/or depressions can be arranged in a cascade from the apex to the base of a structural element of the plurality of structural elements. The number of elevations and/or depressions along a circumferential direction on the lateral surface of a structural element can double in sections from the apex to the base.

The nanoscopic structure can also include cone-like structures, in particular nanocones.

The inventors have found that the nanostructures described above lead to an increased anti-reflective effect.

The nanoscopic structure preferably has an aspect ratio of 0.2 to 3, more preferably of 0.3 to 2, and particularly preferably of 0.5 to 1.2.

The apex of a structural element of the plurality of structural elements can be rounded or flattened. In particular, the apices of all structural elements of the plurality of structural elements can be rounded or flattened. The plurality of structural elements can include structural elements with a rounded and/or flattened apex.

Due to the rounding of the apex, the microstructure is less fragile in terms of mechanical stress.

The apex of a structural element, a subset or all structural elements of the plurality of structural elements can be free of the nanoscopic structure. The apex may not be comprised by the nanoscopic structure. The apex may not have a nanoscopic structure. The apex may not be covered by the nanoscopic structure.

The plurality of structural elements can comprise straight cones and/or oblique cones and/or truncated cones. A subset of the structural elements of the plurality of structural elements can comprise exclusively straight cones, exclusively oblique cones or exclusively truncated cones. Alternatively, all structural elements of the plurality of structural elements can comprise exclusively straight cones, exclusively oblique cones or exclusively truncated cones. The plurality of structural elements can also comprise a combination of cone types, straight cone, oblique cone, and truncated cone.

Preferably, the structural elements, in particular all structural elements, of the plurality of structural elements have a height of 1 to 50 micrometers, in particular 5 to 20 micrometers and/or an aspect ratio of 0.3 to 3, more preferably 0.5 to 1.5, and particularly preferably from 0.7 to 1.3. In particular, the aspect ratio can be in the range from 0.5 to 2. The aspect ratio can also be between 0.25 and 3.25. In the following, “aspect ratio” means the ratio of height to width. The height can also be between 0.5 and 55 micrometers.

In these size ranges, the optical properties, in particular the anti-reflective effect, of the microstructure are optimal.

According to the invention, the plurality of structural elements are arranged on the surface of the substrate with a specified degree of disorder. Preferably, at least a subset of the plurality of structural elements on the surface of the substrate is randomly distributed, in particular pseudo-randomly distributed, or arranged according to a random distribution. The random distribution can be a Gaussian distribution, for example, according to which the positions of the individual structural elements of the at least one subset are distributed on the surface of the substrate and the structural elements can be arranged.

Additionally or alternatively, the specified degree of disorder preferably includes that at least a subset of the plurality of structural elements on the surface of the substrate be displaced or offset by a randomly distributed amount in a randomly distributed direction relative to a predetermined two-dimensional lattice pattern. In other words, the specified degree of disorder preferably includes that at least a subset of the plurality of structural elements on the surface of the substrate be displaced or offset by a randomly distributed amount in a randomly distributed direction relative to a predetermined two-dimensional lattice arrangement of the plurality of structural elements. In principle, the lattice arrangement can be any two-dimensional arrangement, in particular a crystal lattice arrangement, in which the lattice sites are evenly distributed and/or the lattice site distribution follows a periodic pattern. The lattice arrangement is preferably hexagonal. Exactly one structural element or each individual structural element of the plurality of structural elements can be arranged in a manner shifted or offset relative to the lattice arrangement. The plurality of structural elements can be a two-dimensional, in particular horizontal, densely packed packing, in particular densely packed cone packing. The terms “specified” and “predetermined” refer to the fact that the degree of disorder and the lattice arrangement are predefined in the provision process of the structural template according to the invention (see aspect of the method according to the invention below) and are therefore reproducible.

For example, the predetermined lattice arrangement can be a two-dimensional crystal lattice with a square unit cell in which all four corners or lattice sites would be occupied by a structural element. According to this lattice arrangement, all structural elements would be arranged in a horizontal square on the top of the substrate or the upper side of the surface of the substrate. According to the invention, the structural elements are arranged with a certain degree of disorder in relation to the lattice arrangement. This means that, for example, a structural element can be arranged in a manner horizontally deviating from its lattice site, which the structural element would take or occupy according to the predetermined lattice arrangement, or horizontally offset from this lattice site. The position at which the structural element can be disposed on the surface of the substrate can be displaced by a random amount in a random direction in the horizontal plane relative to the position of the lattice site that the structural element would take or occupy according to the predetermined lattice arrangement. However, also all structural elements can be arranged in a displaced manner.

Preferably, the average deviation of the positioning of the structural elements is between 0 and 50 percent of the lattice constant of the lattice arrangement. More preferably, the average deviation in the positioning of the structural elements is between 10 and 40 percent of the lattice constant of the lattice arrangement. The average deviation in the positioning of the structural elements is particularly preferably between 25 and 30 percent of the lattice constant of the lattice arrangement.

Furthermore, the axis of a cone, a subset or all structural elements of the plurality of structural elements can be randomly inclined by a few degrees relative to the base or surface area of the structural elements. The axis can preferably be inclined by 40 degrees, more preferably by 10 degrees, or particularly preferably by 5 degrees. The axis can be inclined between 0 and 45 degrees.

With these inclination values, overhangs of the structural elements, which can be problematic both visually and in terms of process technology, can be avoided. This means that structural elements with a high aspect ratio cannot be tilted as far as flatter structural elements.

Further preferably, the specified degree of disorder comprises that the geometry of at least two structural elements, in particular of all structural elements, of the plurality of structural elements be different from one another. The structural elements can have different heights and/or radii.

This further improves the anti-reflective effect caused by the microstructure.

The height of the at least two structural elements can preferably differ by 10 percent. The maximum negative deviation of the aspect ratio of the structural elements from the maximum value can preferably be 100 percent. The maximum negative deviation of the aspect ratio of the structural elements from the maximum value can more preferably be 50 percent. The maximum negative deviation of the aspect ratio of the structural elements from the maximum value can particularly preferably be 10 percent.

This ensures that, on the one hand, the volume density of the structural elements, i.e. the volume of the structural elements per average surface area of the structural elements, remains constant or only fluctuates by a few percent and, on the other hand, all minima and maxima of the entire structured surface of the structural template lie within a certain corridor or, in other words, value range, for example within −5 percent to +5 percent of the average maximum or minimum value. As a result, unevenness that affects stamping can be reduced and controlled.

Preferably, the plurality of structural elements is arranged such that adjacent structural elements, in particular nearest structural elements, of the plurality of structural elements adjoin one another. In this way, the entire area of the surface of the substrate occupied by the microstructure can be covered by structural elements. Alternatively or additionally, the microscopic structure preferably does not have planar, in particular horizontally planar, surfaces between the structural elements of the plurality of structural elements.

Furthermore, adjacent structural elements can intersect.

The at least one partial area of the surface of the substrate that has the microscopic structure can also be completely covered with the microscopic structural elements of the plurality of structural elements.

The structural template, in particular the microstructure, can have a square, in particular horizontal, surface area of 1 cm₂, for example.

The plurality of structural elements can comprise more than two structural elements. The plurality of structural elements preferably comprises between 100 and 1,000,000 structural elements per square millimeter.

A further aspect of the invention relates to the use of a structural template, as described above, for producing a stamping tool for stamping a thin-film element.

Advantageously, by using the structural template described above, the optimal optical properties of certain plant structures, such as the rose petal, can be imitated and simplified and transferred to a stampable element, but the structural template does not have any unevenness and/or inhomogeneities. By means of the structural template, cost-effective, precise and rapid stamping, in particular in a roll-to-roll process, of a thin-film element, such as a foil for coating a solar module, can be ensured and at the same time shine and diffraction effects of the stamped thin-film element can be reduced or avoided.

A further aspect of the invention relates to a method for providing a structural template for producing a stamping tool for stamping a thin-film element, the method comprising the following steps:
providing data of a microscopic structure that comprises a plurality of microscopic structural elements, wherein the structural elements of the plurality of structural elements each have a nanoscopic structure and the structural elements of the plurality of structural elements are arranged with a degree of disorder relative to one another,
providing a substrate, and
transferring the microscopic structure to the substrate based on the data.

Advantageously, with this method, a structural template, such as that described above, can be provided easily and inexpensively. With the structural template provided by the method, the optimal optical properties of certain plant structures, such as the rose petal, can be imitated and simplified and transferred to a stampable element, but the structural template does not have any unevenness and/or inhomogeneities. With the structural template provided by the method, cost-effective, precise and rapid stamping, particularly in a roll-to-roll process, of a thin-film element, such as a foil for coating a solar module, can be ensured and at the same time shine and diffraction effects of the stamped thin-film element can be reduced or avoided.

All statements made above with regard to the structural template according to the invention and its features can also be transferred to the structural template provided by the method and the individual method steps.

In a first step of the method, the data of the microscopic structure, in particular the geometry and arrangement of the individual structural elements, can be provided using a computer. The computer can be a personal computer, PC, or a computer cluster, for example. The computer can also be part of a provisioning or production apparatus with which the microstructure is transferred to the substrate in a third or final step. The provisioning or production apparatus can be a photolithograph or 3D printer, for example.

Providing the data can include modeling and/or generating the microscopic structure data and/or simulating the microscopic structure.

Providing can include modeling a digital model of the microscopic structure with suitable software, such as a CAD program, and generating the data containing the modeled microstructure. The data describing the microstructure can also be generated and/or provided using a spreadsheet program. The data can be stored on the computer. The microstructure data can also be transmitted via a network for further processing.

Advantageously, by providing the microstructure data, the surface structure of a rose petal, for example, can be simulated and modeled. In addition, any adverse properties such as unevenness or defects in the surface structure can be removed during provisioning.

Preferably, the data includes the geometric parameters of the microscopic structure, structural parameters of the nanoscopic structure, and random parameters for the degree of disorder. The geometric parameters of the microstructure can include, for example, the height, radius, aspect ratio and inclination of the individual structural elements of the plurality of structural elements. Structural parameters of the nanostructure can include, for example, the curvature and length as well as the positioning on the lateral surface of a structural element of the paths of elevations and/or depressions. In other words, the structural parameters of the nanostructure can describe the geometric shape of the nanostructure. The random parameters describe the degree of disorder in the distribution or arrangement of the structural elements of the plurality of structural elements. The random parameters, in particular pseudo-random parameters, can include, for example, two-dimensional lattice coordinates of the individual structural elements of the plurality of structural elements distributed according to a specific probability distribution or random distribution.

For example, the data can include or be a matrix in which each entry indicates the height of a structural element and the row and column index indicate the lattice position of the structural element. A grayscale image, in which the grayscale and location of each pixel corresponds to the height and position of a structural element, can be generated from this matrix.

According to the invention, the plurality of structural elements are arranged on the surface of the substrate with a specified degree of disorder. Preferably, at least a subset of the plurality of structural elements on the surface of the substrate is randomly distributed, in particular pseudo-randomly distributed, or arranged according to a random distribution. The random distribution can be a Gaussian distribution, for example, according to which the positions of the individual structural elements of the at least one subset can be distributed on the surface of the substrate and the structural elements can be arranged.

Preferably, the degree of disorder includes that at least a subset of the plurality of structural elements be displaced or offset by a randomly distributed amount in a randomly distributed direction relative to a two-dimensional lattice arrangement of the plurality of structural elements, with the lattice arrangement being chosen in particular to be hexagonal. The plurality of structural elements can be densely packed. While the data is provided, the lattice arrangement of the plurality of structural elements can be selected, to which the degree of disorder can then be applied, for example based on the above-mentioned random parameters. The lattice arrangement can be any two-dimensional lattice structure, in particular a crystal lattice structure. However, the degree of disorder can also be created by positioning each individual structural element of the plurality of structural elements in a non-regular two-dimensional pattern.

Preferably, the degree of disorder includes that the geometry of at least two structural elements, a subset or all structural elements of the plurality of structural elements be chosen to be different from one another.

Further preferably, the height of the structural elements, in particular all structural elements, of the plurality of structural elements is set to a range of 1 to 50, in particular 5 to 20 micrometers and/or the aspect ratio is set to a range of 0.3 to 3, in particular 0.5 to 2, wherein the height and/or the aspect ratio of the individual cones can be varied within a range of −10 to +10 percent. The height can be set to a range of 5 to 10, 10 to 15, or 15 to 20 micrometer. The aspect ratio can be set to a range of 0.3 to 3, 0.5 to 1.5, or 0.7 to 1.3.

By choosing a geometry of the structural elements and a degree of disorder, the anti-reflective properties of the microstructure can be specifically adjusted and increased. Moreover, it can also be ensured that all minima and maxima of the microstructure lie within a certain corridor or value range, which means that macroscopic unevenness, such as those that can occur across the rose petal, can be avoided. The choice of nanoscopic structure also has a beneficial influence on the physical properties of the microstructure. For example, the nanostructure helps to improve the optical properties of the microstructure and the microstructure has self-cleaning properties, for example in accordance with the surface structure of the rose petal. Due to the nanostructure, foreign particles can no longer stick to the microstructure as easily and due to the changed wetting behavior of water on the structure, particles can be removed more easily.

The data of the microscopic structure is preferably provided in such a way that adjacent structural elements, in particular nearest structural elements, of the plurality of structural elements adjoin one another, with adjacent structural elements in particular intersecting one another. The microstructure may not have any flat areas between the individual structural elements.

This can ensure that the entire area encompassed by the microstructure is covered with structural elements, whereby the anti-reflective properties of the microstructure can be further increased.

In a second step, a substrate can be selected and provided. The substrate can be a negative or positive photoresist, in particular a photoresist. The substrate is preferably a photoresist that cures or polymerizes in the irradiated areas by targeted irradiation with light of a specific wavelength.

In a third step, the hierarchical structure of microstructure with included nanostructure can be transferred to the substrate based on the data provided or generated.

Preferably, transferring the microscopic structure to the substrate is carried out by sintering, laser ablation, multiphoton lithography, laser interference lithography, gray scale lithography, etching or a combination of these methods or by another suitable method.

Transferring can further include providing the provided data of the microscopic structure via a connection, such as a network connection, to a provisioning or production apparatus, such as a photolithographer or 3D printer. The data can be transmitted to this apparatus via the connection.

Steps two and three of the method described above can be carried out entirely in a photolithograph. To this end, the microstructure data can be provided by a computer, i.e. the data can be transferred from the computer to the photolithographer over a connection such as a network. The entire method described above can be carried out even completely and automatically in a photolithograph.

Furthermore, a stamping tool, in particular for roll-to-roll stamping of a foil, can now be produced using the earlier invention (file number 10 2020 209 106.4) with the structural template provided by the method according to the invention, the surface structure of the structural template being duplicated and transferred to the stamping surface of the stamping tool.

A further aspect according to the invention relates to a computer program product including instructions that cause a processor of a computer, on which the instructions are executed, to carry out the method according to the above-described invention for providing a structural template for producing a stamping tool for stamping a thin-film element.

The following is a description of the drawings, which serve to illustrate some embodiments of the present invention and describe further or alternative features. It goes without saying that individual features shown in the drawings can be combined to form further embodiments.

The figures show:

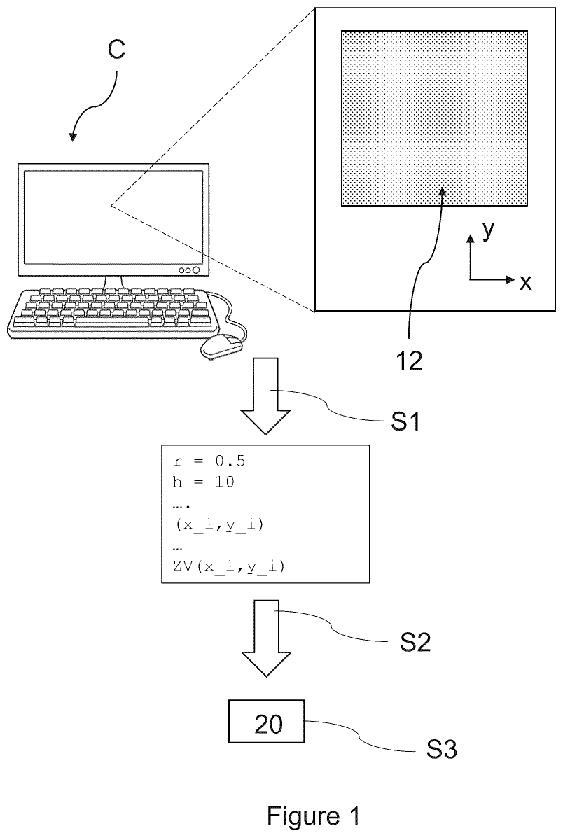

FIG. 1 a schematic representation of the provisioning of the data of a microstructure for producing a structural template according to the invention,

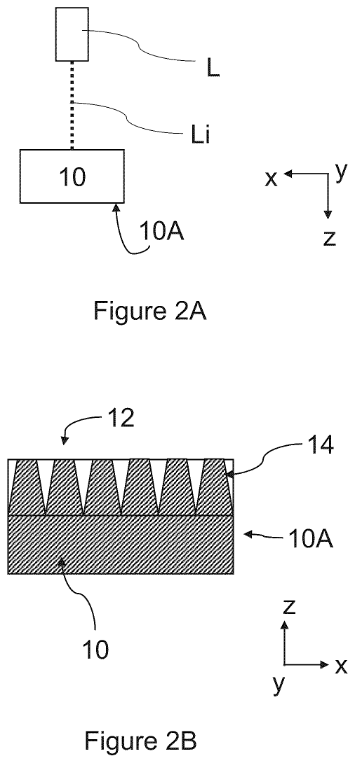

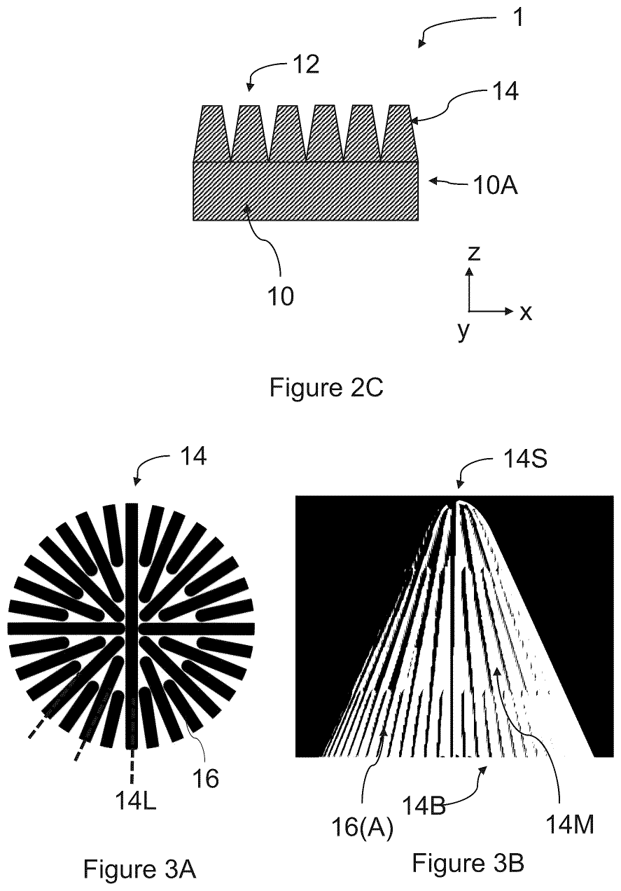

FIG. 2A irradiation of a substrate with laser light in a photolithograph,

FIG. 2B the structured substrate of FIG. 2A,

FIG. 2C a structural template produced by the method according to the invention based on the substrate of FIG. 2B,

FIG. 3A a plan view of a cone of the plurality of cones of the microstructure with visible nanostructure,

FIG. 3B a side view of the cone of FIG. 3A with a rounded apex,

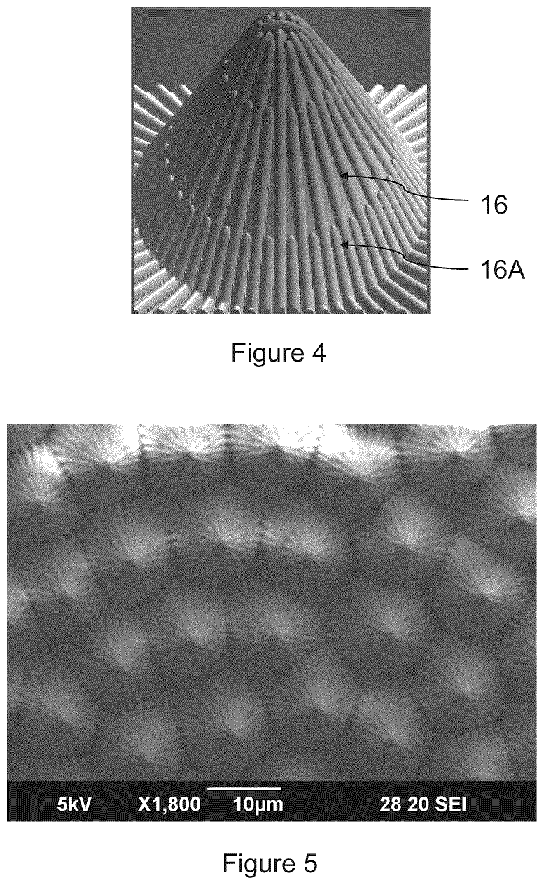

FIG. 4 a 3D view of the cone of FIG. 3B, and

FIG. 5 an electron scanning microscope image of a microstructure produced using the method according to the invention.

FIG. 1 shows schematically the provisioning of data for a microstructure for a structural template according to the invention using a computer C. In the following, the microstructure 12 has microscopic cones as structural elements.

The computer C shown in FIG. 1 is a PC, but can also be a computer cluster. The microstructure 12 can be modeled and simulated from the computer C using software, such as a CAD program. With the CAD program, the individual cones of the microstructure 12, including the nanostructure on the cones, can be arranged next to one another in an x-y plane and the microstructure 12 can thus be modeled and created. In FIG. 1, the cones of the microscopic structure 12 were all arranged to form a square lattice, with the individual rows of cones of the microscopic structure 12 each being offset from one another by one lattice site. The microstructure can also be created fully automatically according to user specifications. The microstructure 12 can be computer generated according to user specifications.

The data defining the microstructure 12 of the cones is generated or provided by the CAD program (step S1) and can be stored. Furthermore, if necessary, the data can be made available for further processing, for example via a network connection. The data includes, for example, the geometric parameters of the cones (radius r, height h) and the nanostructure on the cones, the spatial arrangement of the cones (coordinates (x_i,y_i)), which corresponds to a square lattice arrangement in FIG. 1, as well as the random distribution (ZV(x_i,y_i)) of the cones relative to their respective lattice site with the coordinates x_i, y_i. For example, the cones can be Gaussian-distributed relative to the selected lattice arrangement. The microstructure 12 modeled according to FIG. 1 comprises cones each with a radius of 0.5 micrometers and a height of 10 micrometers each.

The data of the microstructure 12 can also be provided manually, for example using a spreadsheet program (step S1).

Now a substrate is selected depending on the transfer process or production method (step S2).

The microstructure 12 is then transferred to the surface of the substrate using a provisioning or production apparatus 20 based on the data provided and thus a structural template according to the invention is provided or produced (step S3).

In other words: The three-dimensional dimensions and positions of a hierarchical micro- and nanostructure can be generated on the computer C according to the design rules of plant structures that have special anti-reflective properties. The data of cones with a height of 5 to 20 micrometers and an aspect ratio (height to width) of 0.5 to 2 can be selected, provided and generated in a CAD or spreadsheet program. The cone tips can be chosen to be rounded. The nanostructure can include fold-like structures, for example, which extend radially from the tip to the base and support the anti-reflective effect.

Furthermore, the data can include the configuration that individual or all cones (not nanostructure) are arranged in a disordered manner in the x-y plane based on the model of plants. Such an arrangement can eliminate diffraction patterns and shine effects. Starting from, for example, a square or hexagonal positioning of the cones on the plane, which would be strictly periodic and would therefore lead to diffraction effects, the cones can be shifted from their square or hexagonal lattice site by small, randomly distributed amounts in randomly distributed directions, so that no short-range order exists anymore. The shape of the individual cones can vary slightly and be randomly distributed, for example by −10 to +10 percent in height and aspect ratio. In addition, the individual or all cones can be tilted randomly and by a few degrees. The cones can be arranged in such a way that the entire area available to the microstructure 12 is covered by cones.

With the parameters described above, it can be ensured that the volume density of the cones (cone volume per average cone surface area) remains constant or fluctuates only by a few percentage points. Furthermore, it can be ensured that all minima and maxima of the entire structured area of the microstructure lie within a certain corridor or value range, for example within −5 to +5 percent of the average maximum or minimum value. In this way, macroscopic unevenness in the microstructure 12 can be avoided, so that in particular precise and rapid roll-to-roll stamping is possible using the structural template, which can be generated based on the model data of the microstructure 12.

The structural template can be produced in the provisioning apparatus or production apparatus 20 using direct laser writing (DLW) or two-photon lithography. The structural template, created in particular on a small scale, can then be scaled up to industrial dimensions using the invention previously made by the inventors (file number 10 2020 209 106.4).

FIGS. 2A, 2B and 2C schematically show the provisioning process of a structural template according to the invention (step S3) based on previously provided data that depict a model of the microstructure to be transferred to a substrate. A variant of multiphoton lithography is used here to provide or generate the structural template.

First, a cuboid substrate 10 (shown here in cross section) with a surface 10A is selected and provided. The substrate 10 is made of a photoresist material that can be structured by irradiation with light Li of a certain wavelength, for example UV light, by curing at the irradiated points in the volume of the substrate, for example by polymerization. Thus, the substrate can be structured according to a desired microscopic cone structure, which is in data form, for example as a table.

In order to create the microscopic cone structure including the integral nanostructure on the top of the surface 10A of the substrate 10, the substrate 10, as shown schematically in FIG. 2A, is irradiated or exposed (dotted line Li) with a laser L from below (in the z direction), for example. Masks or stencils (not shown here) can also be used for in-plane structuring, with the masks being arranged on the substrate 10 before exposure or irradiation of the photoresist.

FIG. 2B shows the substrate 10 of FIG. 2A, the volume of which has been structured by irradiation with laser light and has the microscopic cone structure 12 (hatched area) inside, with each cone 14 having a nanostructure (not shown here). For the sake of simplicity, the cones 14 of the microstructure 12 are shown here as truncated, straight cones with a flattened apex. The cones extend with their apices in a vertical direction, i.e. z direction, and thus in the exposure or irradiation direction. The cone axes are vertically oriented. The cones can also extend downward in the negative z direction.

In the hatched areas, the substrate 10 has been completely polymerized, whereas in the non-hatched areas the substrate 10 is in its initial state. The non-hatched areas can be removed wet-chemically using an appropriate agent (see FIG. 2C).

FIG. 2C shows the finished structural template 1 (in cross-section) based on the structured substrate 10 of FIG. 2B. The non-hatched areas shown in FIG. 2B were dissolved or removed using wet chemicals. The resulting top of the surface 10A of the cured substrate 10 has the microscopic cone structure 12 with integrated nanostructure (not shown).

This nanoscopic surface structure 16 of the cones 14 of the microstructure 12 is shown based on an example in FIGS. 3A and 3B.

A plan view of a cone 14 of a microstructure 12 is shown in FIG. 3A and a side view of the cone 14 is shown in FIG. 3B. The cone 14 shown has a nanostructure 16 on its lateral surface 14M (in FIG. 3B) from the base 14B or the surface area of the cone to the apex 14S. In the plan view of FIG. 3A, the nanostructure 16 extends radially outward in a beam shape. The nanostructure 16 shown can imitate the structure of plants, such as a rose petal, and be simplified. In the present case, the nanostructure 16 is composed of fold- or tube-like, convex elevations 16A, which extend along different generating or surface lines 14L (dashed line) of the cone 14. The elevations can be arranged next to one another along a circumferential line on the lateral surface 14M, so that there is a depression or a trench between directly adjacent elevations, which also extends from the apex to the base of the cone 14. As shown in FIG. 3A, the elevations 16A can also extend in different sections of the lateral surface. As shown, four paths of elevations can extend from the apex to the base. The next four paths can start slightly below the apex 14S and extend between the first four paths to the base.

Between these four second paths, eight additional paths can extend a section deeper toward the base, and so on. In other words, the elevations 16A can be displaced vertically and radially relative to one another along the lateral surface 14M, so that the number of elevations 16A below the apex 14S increases by a factor of 2. What has been described for the elevations 16A also applies to, in particular, concave depressions or trenches in the lateral surface 14M of the cones 14.

FIG. 3B shows a side view of the cone 14 of FIG. 3A, but here the apex 14S is rounded and the apex 14S does not have a nanostructure 16. In other words, the apex 14S is not comprised or covered by the nanoscopic structure 16. The apex 14S can also be pointed or flat.

FIG. 4 shows a 3D view in grayscale, which cannot be represented otherwise, of the cone 14 of FIG. 3B. The nanoscopic structure 16 can be seen particularly well here.

FIG. 4 shows in particular the above-described cascading arrangement of paths of convex elevations 16A, whereby the fold-like nanostructure 16 is created. Analogously, the nanostructure 16 can also comprise concave depressions or even a combination of elevations and depressions.

FIG. 5 shows an image of the microscopic cone structure 12, which cannot be represented otherwise, by a scanning electron microscope. The image shows a part of the microstructure 12 measuring approximately 80 by 50 micrometers.

In summary, the present invention according to the independent claims can provide a structural template for producing an improved stamping tool, whereby the stamping of a thin-film element, such as an anti-reflective foil, can be improved. Furthermore, the structural template can be produced easily and inexpensively. With this structural template, the optimal optical properties of certain plant structures, such as the rose petal, can be imitated and simplified and transferred to a stampable element, but the structural template does not have any unevenness and/or inhomogeneities. By means of the structural template, cost-effective, precise and rapid stamping, in particular in a roll-to-roll process, of a thin-film element, such as a foil for coating a solar module, can be ensured and at the same time shine and diffraction effects of the stamped thin-film element can be reduced or avoided. In particular, the anti-reflective effect can be further improved by providing a nanoscopic structure on the structural elements of the microstructure. In other words, by providing a nanoscopic structure on the structural elements, the anti-reflective properties of a thin-film element into which the microscopic structure has been stamped can be improved. In addition, the nanoscopic structure has the effect that foreign particles cannot adhere to the microscopic structure, which gives the microscopic structure self-cleaning properties. Due to the disorder in the arrangement of the structural elements, there is no short-range or long-range order in the microscopic structure, whereby diffraction effects and shine of the thin-film element into which the microscopic structure has been stamped can be reduced or eliminated.

### REFERENCE NUMERAL LIST

1 structural template
10 substrate
10A surface of the substrate
12 microscopic structure
14 structural elements
14M lateral surface of a structural element
14L generating or surface line of a structural element
14S apex of a structural element
14B base of a structural element
16 nanoscopic structure
16A elevations and/or depressions
20 provisioning or production apparatus
C computers
L laser
Li light

1. A structural template for producing a stamping tool for stamping a thin-film element, the structural template comprising:
a substrate with a surface,
wherein at least a partial area of the surface has a microscopic structure that comprises a plurality of microscopic structural elements,
wherein the plurality of microscopic structural elements each have a nanoscopic structure, and
wherein the plurality of microscopic structural elements are arranged on the surface of the substrate with a specified degree of disorder.

2. The structural template according to claim 1, wherein the plurality of microscopic structural elements comprises a plurality of microscopic cones.

3. The structural template according to claim 1, wherein all structural elements of the plurality of structural elements have a nanoscopic structure, and/or
wherein the nanoscopic structure of a structural element of the plurality of structural elements is formed in a lateral surface of the structural element.

4. The structural template according to claim 1, wherein all structural elements of the plurality of structural elements have an identical nanoscopic structure, or
wherein the nanoscopic structure of at least two structural elements of the plurality of structural elements differs.

5. The structural template according to claim 1, wherein the nanoscopic structure comprises elevations and/or depressions that extend in paths between an apex and a base of a structural element of the plurality of structural elements along a generating or surface line of the structural element, wherein the nanoscopic structure comprises folds that extend between the apex and the base of a structural element of the plurality of structural elements along a generating or surface line of the structural element.

6. The structural template according to claim 1, wherein an apex of a structural element of the plurality of structural elements is rounded or flattened.

7. The structural template according to claim 1, wherein the plurality of structural elements each have a height of 1 to 50 micrometers and/or an aspect ratio of 0.3 to 3.

8. The structural template according to claim 1, wherein the plurality of structural elements comprises straight cones and/or oblique cones and/or truncated cones.

9. The structural template according to claim 1, wherein at least a subset of the plurality of structural elements on the surface of the substrate is randomly distributed or arranged according to a random distribution, and/or
wherein the specified degree of disorder comprises that at least a subset of the plurality of structural elements on the surface of the substrate be displaced or offset by a randomly distributed amount in a randomly distributed direction relative to a predetermined two-dimensional lattice arrangement of the plurality of structural elements, wherein the lattice arrangement is hexagonal.

10. The structural template according to claim 1, wherein the specified degree of disorder comprises that the geometry of at least two structural elements of the plurality of structural elements be different from one another.

11. The structural template according to claim 10, wherein the height and/or the aspect ratio of the at least two structural elements differs by 10 percent.

12. The structural template according to claim 1, wherein the plurality of structural elements is arranged such that adjacent structural elements of the plurality of structural elements adjoin one another, and/or
wherein the microscopic structure does not have planar surfaces between the structural elements of the plurality of structural elements, and/or
wherein the at least one partial area of the surface of the substrate, which has the microscopic structure, is completely covered with the microscopic structural elements of the plurality of microscopic structural elements.

13. The structural template according to claim 12, wherein adjacent structural elements intersect at lateral surfaces thereof.

14. A use of a structural template according to claim 1 for producing a stamping tool for stamping a thin-film element.

15. A method for providing a structural template for producing a stamping tool for stamping a thin-film element, the method comprising:
providing data of a microscopic structure that comprises a plurality of microscopic structural elements, wherein the plurality of microscopic structural elements each have a nanoscopic structure and the plurality of microscopic structural elements are arranged with a degree of disorder relative to one another,
providing a substrate, and
transferring the microscopic structure to the substrate based on the data.

16. The method according to claim 15, wherein the data comprises geometric parameters of the microscopic structure, structural parameters of the nanoscopic, and random parameters for the degree of disorder.

17. The method according to claim 15, wherein at least a subset of the plurality of structural elements on the surface of the substrate is randomly distributed, pseudo-randomly distributed, or arranged according to a random distribution, and/or
wherein the degree of disorder comprises that at least a subset of the plurality of structural elements be displaced or offset by a randomly distributed amount in a randomly distributed direction relative to a two-dimensional lattice arrangement of the plurality of structural elements, wherein the lattice arrangement is hexagonal.

18. The method according to claim 15, wherein the degree of disorder comprises that the geometry of at least two structural elements of the plurality of structural elements be chosen to be different from one another.

19. The method according to claim 15, wherein a height of the plurality of structural elements is set to a range of 1 to 50 and/or the aspect ratio is set to a range of 0.3 to 3, and/or wherein the height and/or the aspect ratio of the individual structural elements is varied in a range from −10 to +10 percent.

20. The method according to claim 15, wherein the data of the microscopic structure is provided such that adjacent structural elements of the plurality of structural elements adjoin one another and intersect one another.

21. The method according to claim 15, wherein transferring the microscopic structure to the substrate is carried out by sintering, laser interference lithography, grayscale lithography, laser ablation, multiphoton lithography, etching, or any combination thereof.

22. A computer program product including instructions that cause a processor of a computer, on which the instructions are executed, to carry out a method for providing a structural template for producing a stamping tool for stamping a thin-film element, the method comprising:
providing data of a microscopic structure that comprises a plurality of microscopic structural elements, wherein the plurality of microscopic structural elements each have a nanoscopic structure and the plurality of microscopic structural elements are arranged with a degree of disorder relative to one another; and
causing transferring of the microscopic structure to a substrate based on the data.
